(19) United States
(12) Patent Application Publication
(10) Pub. No.: US 2014/0102840 A1
(43) Pub. Date: Apr. 17, 2014

(54) ROTARY TYPE DAMPER

(71) Applicant: Yongjun Cho, Gyeonggi - do (KR)

(72) Inventor: Yongjun Cho, Gyeonggi - do (KR)

(73) Assignee: EVERSYS CO., LTD., Hwaseong - si, Gyeonggi - do (KR)

(21) Appl. No.: 14/115,945

(22) PCT Filed: May 7, 2012
(86) PCT No.: PCT/KR2012/003549

§ 371 Date: Nov. 14, 2013

(30) Foreign Application Priority Data
May 6, 2011 (KR) 10-2011-0042888

(51) Int. Cl. F16F 9/12; F16F 9/516

(52) U.S. Cl. CPC F16F 9/12; F16F 9/516
USPC 188/281; 188/290

(57) ABSTRACT

A rotary-type damper includes a housing filled with a working fluid, a shaft penetrating inside the housing and placed in a rotatable manner, a housing pin provided on the inner circumference of the housing to reach the side of the shaft used for limiting the movement of the working fluid, and an axis pin for coupling with the shaft to rotate with the shaft, and closely contacting the side of the shaft and the inner circumference of the housing as the position thereof varies according to the rotating direction of the shaft. The present invention increases the durability and the period of use, easily enables an accurate control of the working fluid, thereby eliminating the requirement for high precision in processing the component members, and enables the control of a unidirectional damping and the rotational speed of a rotary body which is the target of damping.

### CROSS REFERENCE TO RELATED APPLICATIONS AND CLAIM OF PRIORITY

This patent application is a National Phase application under 35 U.S.C. §371 of International Application No. PCT/KR2012/003549, filed May 7, 2012, which claims priority to Korean Patent Application No. 10-2011-0042888 filed May 6, 2011, entire contents of which are incorporated herein by reference.

### BACKGROUND

1. Field of the Invention

The present invention relates to a rotary-type damper, and more particularly, to a rotary-type damper wherein the durability and the period of use thereof is increased by minimizing the contact area between component members thereof, and reducing abrasions of the components during operation. Moreover, a rotary-type damper capable of controlling uni-directional dampening and rotational speed of a rotary body is described.

2. Description of the Related Art

In general, a damper is an apparatus configured to absorb vibration energy. A damper can also be referred to as a vibration controller or a vibration absorber. Among such dampers, a rotary damper is used to gently control the rotational speed of a rotary body by applying a predetermined braking force to the rotary body.

In the rotary-type oil damper described herein, the dampening function is performed using oil and will be described with reference to the accompanying drawings below.

FIG. 1 is a cross-sectional view of a conventional rotary-type oil damper disclosed in Korean registered patent No. 0205091 entitled, “Keyboard Lid Opening and Closing Device Using Oil Damper”.

As illustrated in FIG. 1, the conventional oil damper 3 includes a casing 8, including a hollow cylindrical chamber 6 with one end facing a shaft of which is closed and another end of which is open, and the inside of which is filled with a viscosity fluid 7; a pivoting member (not shown) assembled to be rotatable with respect to the casing 8 and includes a shaft unit 9 disposed in the chamber 6 to be rotated along a shaft line of the casing 8; a protrusion portion 10 extending in a shaft direction and along the peripheral surfaces of the shaft unit 9; a movable valve 11, coupled to the protrusion portion 10, having an opening in a rotational direction and having a side in contact with the protrusion portion 10 in the rotational direction of the casing 8; fluid passages 12, 13, and 14 formed on the interface between the movable valve 11 and the protrusion portion 10 and one side and another side of the movable valve 11, respectively, to cause the viscosity fluid 7, having a resistance, to pass through the movable valve 11 as the casing 8 and the pivoting member (not shown) rotate relatively to one another; and a sealing member (not shown) including, for example, an O-shaped ring installed between the casing 8 and the pivoting member (not shown) to seal the viscosity fluid 7.

The casing 8 is installed on a place where the oil damper 3 is applied by tightening a screw. More specifically, the movable valve 11 is formed such that a cross section thereof comprises a channel shape. The distance between vertical walls 17 and 18, both of which are the ends of the movable valve 11 in terms of the rotational direction of 11, is actually greater than the width of the protrusion portion 10 in terms of the rotational direction of 10. The movable valve 11 has an opening in the rotational direction of 11, is placed on the protrusion portion 10, and may be moved in a sliding manner to contact a surface of the inner wall 19 of casing 8. The fluid passages 12 and 13 are actually formed on the vertical walls 17 and 18 of movable valve 11, respectively, and the fluid passage 14 is formed by partially cutting the protrusion portion 10. A stopper 23 extends in the shaft direction and is installed on the inner wall 19 of the chamber 6.

In the conventional rotary-type oil damper 3 described above, when the casing 8 starts to rotate in the direction indicated by the arrow (i.e., in a counterclockwise direction), the movable valve 11 is rotated by the viscosity fluid 7 as the stopper 23 rotates, thereby causing the vertical wall 18 to come into contact with the protrusion portion 10. Consequently, the viscosity fluid 7 flows from fluid passage 13, via fluid passage 14, and then flows in the direction of the opening between vertical wall 17 and protrusion portion 10, thereby decreasing the resistance of the viscosity fluid 7.

Furthermore, when casing 8 starts to rotate in the opposite direction (i.e., in a clockwise direction), stopper 23 is in a fully open state wherein stopper 23 is in contact with protrusion portion 10, via movable valve 11, and vertical wall 17 of movable valve 11 consequently comes in to contact with protrusion portion 10. In this case, viscosity fluid 7 flows into fluid passage 12, having a small cross section, and thus generates very high resistance.

In conventional rotary-type oil dampers, the component members are likely to abrade during operation due to surface contact between the component members, thereby decreasing the durability and periods of use.

Furthermore, in conventional rotary-type oil dampers, working fluids are difficult to control accurately, and the component members are thus required to be precisely processed, thereby increasing the efforts and costs to manufacture conventional rotary-type oil dampers like 3.

In conventional rotary-type oil dampers, mechanisms configured to generate resistance for working fluids are complicated, and accurately controlling the resistance of working fluids is equally limited during operations, thereby lowering the reliability of the dampening action.

Lastly, conventional rotary-type oil dampers are not capable of controlling the unidirectional dampening and rotational speed of a rotary body, and are thus inapplicable to rotary bodies that require unidirectional dampening or variable rotational speeds.

### SUMMARY

The present invention provides a rotary-type damper wherein the durability and period of use are increased by minimizing the contact area between the component members thereof, thereby decreasing abrasions of the component members during operation.

The present invention also provides a rotary-type damper which is capable of accurately controlling the working fluid and thereby does not require the precise processing of the component members thereof, thus reducing the effort and costs to manufacture the rotary-type damper.

The present invention also provides a rotary-type damper capable of accurately controlling the resistance of the working fluid, thereby improving the reliability of the dampening action.

The present invention also provides a rotary-type damper that is capable of controlling the unidirectional dampening and rotational speed of a rotary body, thus making it easily applicable to a rotary body that requires unidirectional dampening or variable rotational speeds.

Additional aspects of the present invention will be set forth in part in the description which follows and, in part, will be apparent from the description, or may be learned by practice of the presented embodiments.

According to an aspect of the present invention, there is provided a rotary type damper including a housing filled with a working fluid; a shaft installed to be rotatable while passing through the inside of the housing; a housing pin placed on an inner circumference of the housing to reach a side of the shaft, and configured to limit the movement of the working fluid; and an axis pin coupled to the shaft to rotate together with the shaft, and closely contacting the side of the shaft and the inner circumference of the housing as the position of the axis pin varies according to a rotation direction of the shaft.

The axis pin may be coupled to the side of the shaft such that the axis pin rotates in opposite directions according to the rotation direction of the shaft and a resistance between the axis pin and the working fluid thereby.

Both sides of the axis pin may closely contact the side of the shaft and the inner circumference of the housing, respectively, according to the resistance of the working fluid, with respect to the center of the axis pin.

The axis pin may be meshed with the shaft in a circumferential direction of the shaft while having a clearance with the shaft.

A first insertion groove having a curvature may be formed in one of a side of the axis pin and a side of the shaft, and a first insertion projection having a curvature may be formed on the other to be inserted into the first insertion groove.

A pair of first insertion grooves and a pair of first insertion projections may be formed in parallel at a predetermined interval.

Linear contact portions may be formed at both sides of the axis pin to cause the axis pin to linearly contact the inner circumference of the housing when the axis pin closely contacts the inner circumference of the housing.

Both side surfaces of the axis pin may be formed to be inclined with respect to a radius of rotation of the shaft.

A resistance decrease groove may be formed in the axis pin to allow the working fluid therethrough when the shaft rotates only in one direction.

The resistance decrease groove may be formed in a side of a surface of the axis pin facing the inner circumference of the housing.

A friction decrease groove may be formed in the surface of the axis pin facing the inner circumference of the housing in a lengthwise direction to be connected to the resistance decrease groove.

The housing pin may be installed on the housing such that the position of the housing pin varies according to the rotation direction of the shaft and a resistance of the working fluid thereby, and to cause the housing pin to closely contact the side of the shaft and the inner circumference of the housing.

The housing pin may be meshed with the inner circumference of the housing in a circumferential direction of the housing while having a clearance with the housing.

A second insertion groove having a curvature may be formed in one of the housing pin and the inner circumference of the housing, and a second insertion projection having a curvature may be formed on the other to be inserted into the second insertion groove.

The housing pin may be shaft-coupled to a bottom surface of the housing to be rotatable with respect to the bottom surface of the housing.

Linear contact portions may be formed at both sides of a portion of the housing pin facing the shaft to cause the housing pin to linearly contact the shaft when the housing pin closely contacts the shaft.

Both side surfaces of the housing pin may be formed to be inclined with respect to the radius of rotation of the shaft.

The durability and period of use of a rotary type damper according to the present invention may be increased by minimizing a contact area between component members thereof to decrease abrasion of the component members during an operation. Also, the rotary type damper is capable of accurately controlling a working fluid and thus does not require a high precision and accuracy to process the component members, thereby reducing the efforts and costs to manufacture the rotary type damper. Also, the rotary type damper is capable of accurately controlling a resistance of the working fluid to improve the reliability of a damping action and controlling a unidirectional damping and a rotational speed of a rotary body which is a target of damping, and is thus easily applicable to a rotary body that requires a unidirectional damping or a variable rotational speed.

### BRIEF DESCRIPTION OF THE DRAWINGS

FIG. 1 is a cross-sectional view of a conventional rotary type oil damper,

FIG. 2 is an exploded perspective view of a rotary type damper according to a first embodiment of the present invention,

FIG. 3 is a side cross-sectional view of the rotary type damper according to the first embodiment of the present invention,

FIG. 4 is an enlarged view of main parts of the rotary type damper of FIG. 3,

FIG. 5 is a perspective view of the rotary type damper according to the first embodiment of the present invention,

FIG. 6 is a plan view of a state in which an axis pin is closed in the rotary type damper according to the first embodiment of the present invention,

FIG. 7 is an enlarged plan view of main parts of the rotary type damper of FIG. 6,

FIG. 8 is a plan view of another state in which the axis pin is closed in the rotary type damper according to the first embodiment of the present invention,

FIG. 9 is an enlarged plan view of main parts of the rotary type damper of FIG. 8,

FIGS. 10 and 11 are plan views illustrating an operation of a housing pin of the rotary type damper according to the first embodiment of the present invention,

FIG. 12 is a plan view of various examples of the housing pin of the rotary type damper according to the first embodiment of the present invention,

FIG. 13 is an exploded perspective view of a rotary type damper according to a second embodiment of the present invention,

FIGS. 14 to 16 are plan views of states in which an axis pin is closed in the rotary type damper according to the second embodiment of the present invention,

FIG. 17 is an enlarged plan view of main parts of the rotary type damper in which the axis pin is closed in the rotary type damper according to the second embodiment of the present invention,

FIGS. 18 to 20 are plan views of states in which the axis pin is open in the rotary type damper according to the second embodiment of the present invention, and

FIG. 21 is an enlarged plan view of main parts of the rotary type damper in which the axis pin is open according to the second embodiment of the present invention.

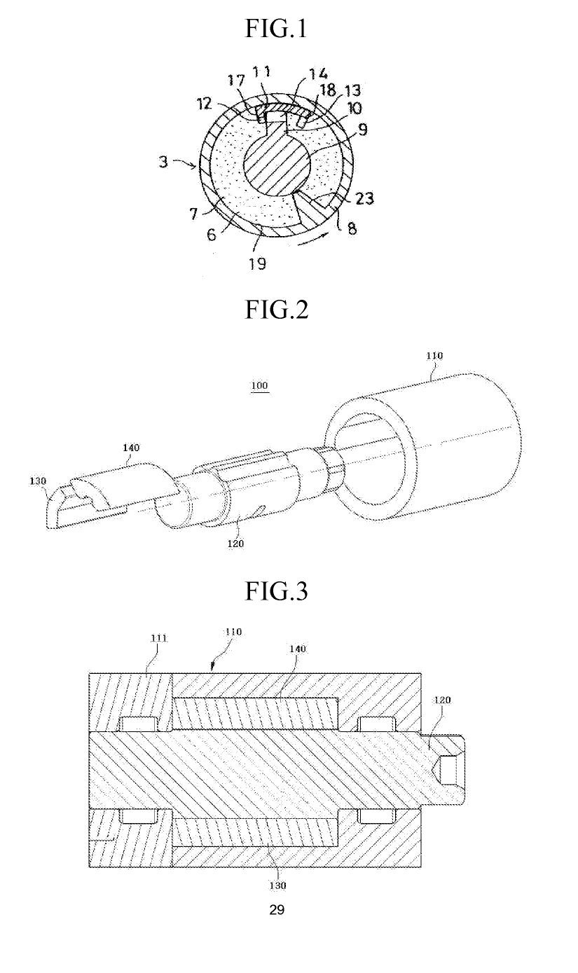

### DETAILED DESCRIPTION

The present invention may be embodied in different forms and in various embodiments. Thus, exemplary embodiments of the present invention will be illustrated in the drawings and described in detail below. However, the present invention is not limited to the embodiments set forth herein. Exemplary embodiments are described so as to cover all modifications, equivalents, and alternatives falling within the scope of the present invention. Accordingly, it will be understood that various changes in form and detail may be made therein without departing from the spirit and scope of the following claims.

Hereinafter, exemplary embodiments of the present invention will be described in detail with reference to the accompanying drawings. The same or corresponding component members are assigned the same reference numerals and are not redundantly described herein.

FIG. 2 is an expanded perspective view of a rotary type damper 100 according to a first embodiment of the present invention. FIG. 3 is a side cross-sectional view of the rotary type damper 100 according to the first embodiment of the present invention.

As illustrated in FIGS. 2 and 3, the rotary type damper 100, according to the first embodiment of the present invention, may include a housing 110 filled with a working fluid 1, a shaft 120 installed within the housing 110, a housing pin 130 placed on an inner circumference of the housing 110, and an axis pin 140 placed on the shaft 120 such that the position thereof is variable. Examples of a rotary body include various doors, robot arms, wheels, rotary mechanisms, rotation members, rotation devices, and the like. Here, working fluid 1 may be one of various viscous fluids such as oils and the like.

The inside of the housing 110 is filled with the working fluid 1 such that the working fluid 1 does not leak. A cap 111 is coupled to a side of the housing 110 and detachable so that the inside of the housing 110 may be opened. A sealing member may be interposed between a portion of housing 110 and a portion of cap 111, which are coupled to each other, so as to make an air-tight seal with the housing 110, and may be fixed on, for example, a supporting structure for supporting the rotary body directly or via a bracket or additional member.

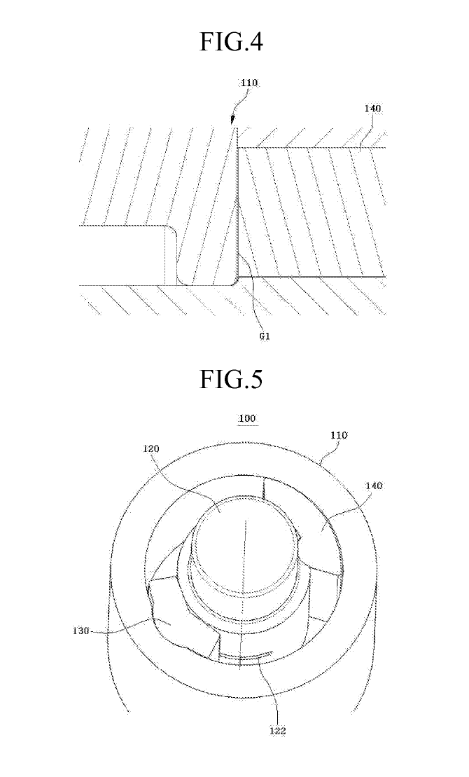

As illustrated in FIG. 4, the housing 110 may have a gap G1 allowing flow of the working fluid 1, via tolerance between an inner side of the housing 110 and the housing pin 130 illustrated in FIG. 3, or between the inner side of the housing 110 and the axis pin 140; or processing a portion between the inner side of housing 110 and the housing pin 130 illustrated in FIG. 3, or between the inner side of the housing 110 and the axis pin 140. Thus, the working fluid 1 may pass through the housing 130 and the axis pin 140 via the gap G1. The size of the gap G1 may vary according to dampening characteristics.

In the housing 110, the working fluid 1 may travel between both spaces defined by the housing pin 130 and the axis pin 140 by forming a groove on a surface of the inner side of the housing 110, or forming a groove on an outer circumference of the shaft 120, or forming a hole to pass through the shaft 120, or using a tolerance between the component members (e.g., an assembling tolerance of the housing 110, shaft 120, housing pin 130, and axis pin 140. Such a flow of the working fluid 1 may also be applied to all other embodiments wherein one or a plurality of methods above may be used. When the movement of the working fluid 1 is allowed to bypass the housing pin 130 via a fluid path groove 122 on the outer circumference of the shaft 120, the rotational speed of the shaft 120 may be easily controlled using changes in the cross-sectional area or specifications of the fluid path groove 122.

The shaft 120 is installed to be rotatable within the inside of the housing 110, and one or both ends of the shaft 120 may be exposed to or protrude from the housing 110, thereby fixing the rotary body. Thus, the rotary-type damper 100 is configured to absorb the rotational energy generated by the rotational movement of the rotary body. The rotary body may be returned to its original position via a restoring member, such as a spring, and the rotary-type damper 100 may absorb rotational energy when the rotary body is returned to its original position.

The shaft 120 may be installed in the housing 110 to be rotatable via a bearing, and a sealing member may be installed in a contact area between the shaft 120 and the housing 110.

Rotation of the shaft 120 means rotation of the shaft 120 relative to the housing 110, and may be applied throughout the present disclosure. Thus, the shaft 120 may function as a fixed shaft to fix the rotary body into the housing 110.

The housing pin 130 is placed on the inner circumference of the housing 110 so that the housing pin 130 may reach a side of the shaft 120 to limit the movement of the working fluid 1. Here, the limiting of the movement of the working fluid 1 includes not only completely blocking the movement of the working fluid 1 via the housing pin 130, but also allows minute movement of the working fluid 1 through a clearance between the housing pin 130 and the shaft 120. Thus, in rotary-type dampers according to the present embodiment and subsequent embodiments, the housing pin 130 and the axis pin 140 are configured to completely block the movement of the working fluid 1, but still allow the minute movement of the working fluid 1, as described above with respect to the limiting of the movement of the working fluid 1, thereby allowing the rotation of the shaft 120.

As illustrated in FIGS. 5 to 9, the axis pin 140 is coupled to the shaft 120 so that the axis pin 140 may be rotated together with the shaft 120, and the position of the axis pin 140 may vary according to a rotational direction of the shaft 120. Thus, the axis pin 140 may closely contact a side of the shaft 120 and the inner circumference of the housing 110.

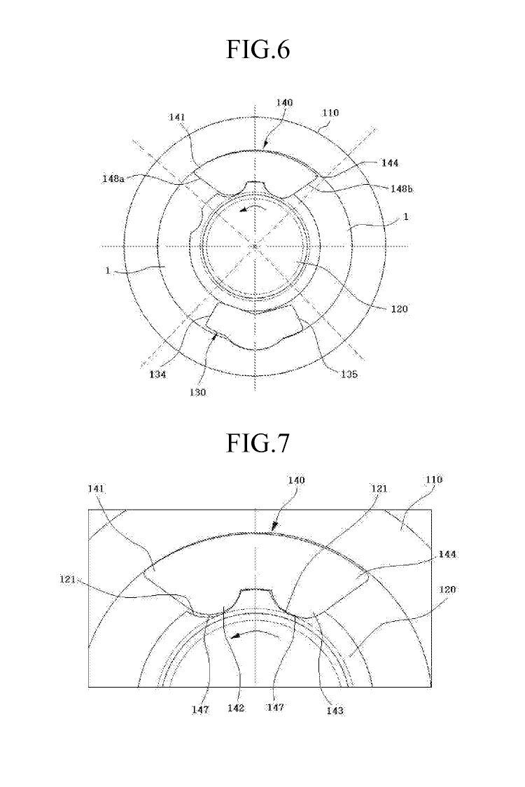

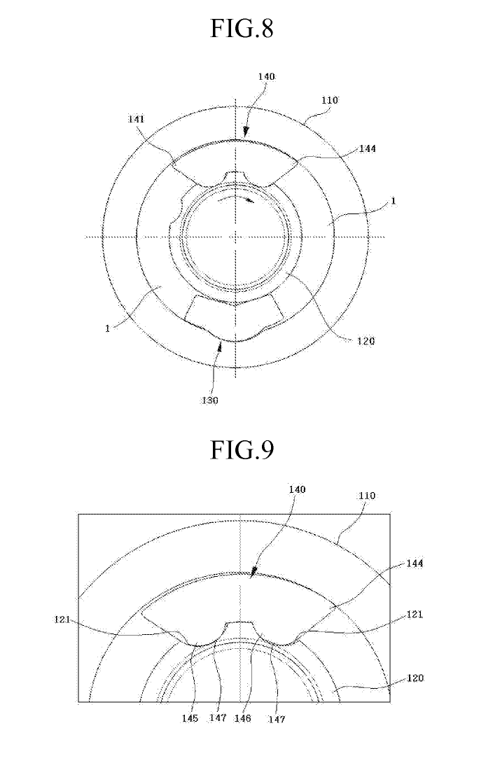

Alternatively, the axis pin 140 may be coupled to a side of the shaft 120 so that the axis pin 140 may rotate in a direction opposite the rotational direction of the shaft 120 due to resistance between the axis pin 140 and the working fluid 1. For example, when the shaft 120 rotates in a counterclockwise direction as illustrated in FIG. 6, the axis pin 140 is moved in a direction while rotating due to a resistance of the working fluid 1 to cause contact portions 141, 142, and 143 to closely contact the inner circumference of the housing 110 and the side of the shaft 120, thereby suppressing the movement of the working fluid 1, as illustrated in FIG. 7. When the shaft 120 rotates in a clockwise direction, as illustrated in FIG. 8, the axis pin 140 is moved in a counterclockwise direction while rotating due to the resistance of the working fluid 1 thereby causing other contact portions 144, 145, and 146 to closely contact the inner circumference of the housing 110 and the side of the shaft 120, thereby suppressing the movement of the working fluid, as illustrated in FIG. 9.

As in the present embodiment, the linear contact portions 141 and 144 among the contact portions 141 to 146 may be formed at both ends of the axis pin 140 to cause the axis pin 140 to linearly contact the inner circumference of the housing 110 when the axis pin 140 closely contacts the inner circumference of the housing 110. The linear contact portions 141 and 144 may have any shape necessary to linearly contact the inner circumference of the housing 110 and reduce abrasion of the axis pin 140 when the axis pin 140 comes into contact with the inner circumference of the housing 110, thereby making it easier to manufacture the axis pin 140. The axis pin 140 may be shaped such that the contact portions 142, 143, 145, and 146, and not linear contact portions 141 and 144, linearly contact the side of the shaft 120.

A side of the axis pin 140 facing the inner circumference of the housing 110 may be formed to have a curvature that is same as or similar to that of the housing 110 without limitation, and may have any of other various shapes.

As in the present embodiment, both sides of the axis pin 140 may closely contact the side of the shaft 120 and the inner circumference of the housing 110, respectively, with respect to the center of the axis pin 140 (e.g., a radius of rotation passing through the center of the axis pin 140) according to the resistance of the working fluid 1. In this case, the both sides of the axis pin 140 may be symmetric to each other with respect to the center of the axis pin 140. Otherwise, both sides of the axis pin 140 may be formed asymmetric to one another.

As illustrated in FIGS. 7 and 9, the axis pin 140 may be meshed with the shaft 120 along a circumferential direction of the shaft 120 while still having clearance with the shaft 120. To this end, for example, a first insertion groove 121 having a curvature may be formed on one side of the axis pin 140 and on a side of the shaft 120, and a first insertion projection 147 having a curvature may be formed on the other side to be inserted into the first insertion groove 121. In the present embodiment, the first insertion groove 121 is formed into the shaft 120 and the first insertion projection 147 is formed on the axis pin 140, without limitation wherein the locations of the first insertion groove 121 and the first insertion projection 147 may be switched relative to one another.

The number of each of the first insertion grooves 121 and the first insertion projections 147 may be one or greater than one. Alternatively, as in the present embodiment, a pair of insertion grooves 121 and a pair of insertion projections 147 may be formed in parallel at predetermined intervals so that the axis pin 140 may stably rotate with respect to the shaft 120 to change the position thereof.

As illustrated in FIG. 6, both side surfaces 148a and 148b of the axis pin 140 may be formed to be inclined with respect to the radius of rotation of the shaft 120 so that the axis pin 140 may be easily moved while rotating by the pressure of working fluid 1.

The housing pin 130 may protrude from the inner circumference of the housing 110 to be integrally formed with the housing 110. Alternatively, as in the present embodiment, the housing pin 130 may be formed separately from the housing 110 and installed on the housing 110. For example, the housing pin 130 may be installed on the housing 110 (e.g., the inner circumference of the housing 110) to closely contact a side of the shaft 120 and the inner circumference of the housing 110 as the position of the housing pin 130 may vary according to the rotational direction of the shaft 120 and the resistance of the working fluid 1.

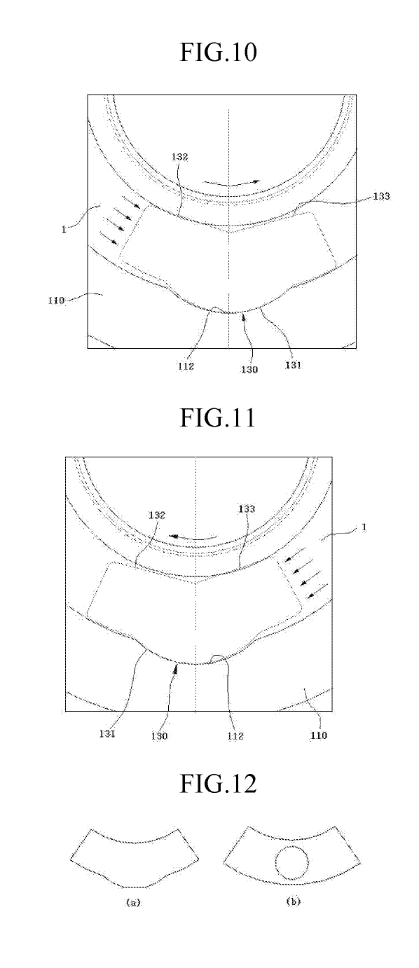

As illustrated in FIGS. 10 and 11, the housing pin 130 may be meshed with the inner circumference of the housing 110 in the circumferential direction of the housing 110 while still having clearance with the housing 110. For example, a second insertion groove 112 having a curvature may be formed on one of the housing pins 130 and the inner circumference of the housing 110, and a second insertion projection 131 having a curvature may be formed on the other to be inserted into the second insertion groove 112. Here, as in the present embodiment, the second insertion projection 131 may be formed on the housing pin 130, and the second insertion groove 112 may be formed on the inner circumference of the housing 110, without limitation wherein the locations of the second insertion projection 131 and the second insertion groove 112 may be switched to relative to one another.

Both sides of the housing pin 130 may be formed to be symmetric to each other as in the present invention or may be formed to be asymmetric to each other. As illustrated in FIGS. 12(a) and (b), the housing pin 130 may have various shapes. Referring to FIG. 12(b), the housing pin 130 may be shaft-coupled to a bottom surface of the housing 110 by forming a shaft hole, a shaft groove, or a shaft thereon so that the housing pin 130 may rotate with respect to the bottom surface of the housing 110.

Linear contact portions 132 and 133 may be formed on both sides of a portion of the housing pin 130 facing the shaft 120 so that the housing pin 130 may linearly contact the shaft 120. Here, each of the linear contact portions 132 and 133 may be in a linear shape as in the present embodiment, but may also be in a curved shape or a combination of linear and curved shapes. Thus, when the shaft 120 rotates in a counterclockwise direction as illustrated in FIG. 6, the housing pin 130 is rotated, or is moved while rotating, in one direction by the pressure of the working fluid 1 compressed by the axis pin 140 as illustrated in FIG. 10. Thus, the linear contact portion 132 on one side of the housing pin 130 comes in close contact with the inner circumference of the shaft 120, and the second insertion projection 131 comes in close contact with the inside of the second insertion groove 112, thereby preventing the working fluid 1 from being moved by the housing pin 130. Also, when the shaft 120 rotates in the clockwise direction as illustrated in FIG. 8, the housing pin 130 is rotated, or is moved while rotating, in another direction by the pressure of the working fluid 1 compressed by the axis pin 140 as illustrated in FIG. 11. Thus, the linear contact portion 133 on another side of the housing pin 130 comes in close contact with the inner circumference of the shaft 120 and the second insertion projection 131 comes in close contact with the inside of the second insertion groove 112, thereby preventing the working fluid 1 from being moved by the housing pin 130.

Both side surfaces 134 and 135 of the housing pin 130 may be formed to be inclined with respect to the radius of rotation of the shaft 120 as illustrated in FIG. 6. Thus, a moment may be easily applied onto the housing pin 130 to rotate or to make a rotational motion by the pressure of the working fluid 1.

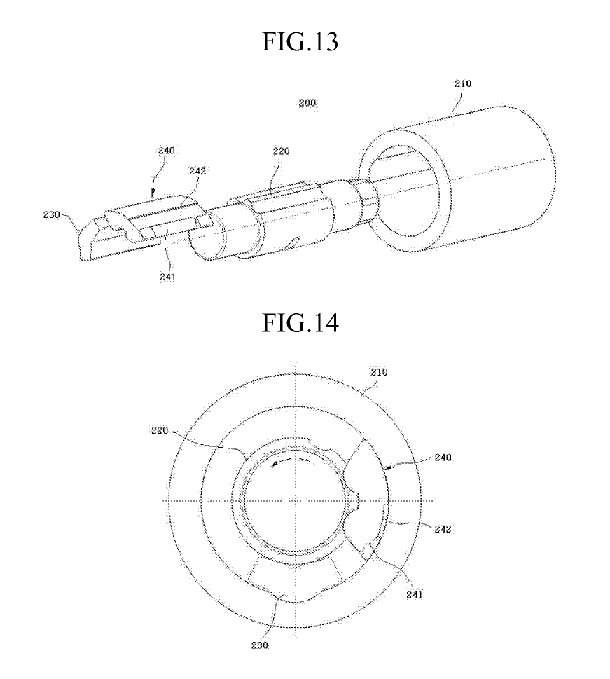

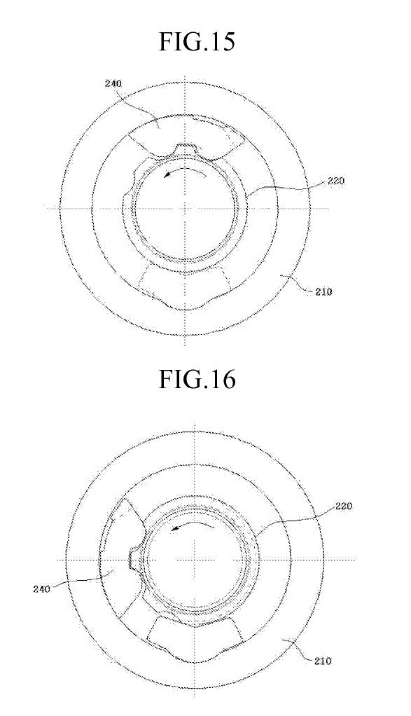

FIG. 13 is an expanded perspective view of a rotary-type damper 200 according to a second embodiment of the present invention. FIG. 14 is a plan view of the rotary type damper 200 according to the second embodiment of the present invention.

As illustrated in FIGS. 13 and 14, the rotary type damper 200 according to the second embodiment of the present invention may include a housing 210, a shaft 220, a housing pin 230, and an axis pin 240, akin to the rotary-type damper 100 according to the first embodiment of the present invention. The rotary-type damper 200 differs from the rotary-type damper 100 in that a resistance decrease groove 241 is formed in the axis pin 240 so that working fluid is allowed to pass through the axis pin 240, when the shaft 220 only rotates in one direction. Thus, in the rotary-type damper 200, the working fluid is prevented from moving in one direction by the axis pin 240 thereby allowing movement in only the other direction, thus enabling unidirectional dampening.

The resistance decrease groove 241 may be formed in various locations on the axis pin 240 and in various shapes to allow the working fluid to only move in one direction. For example, the resistance decrease groove 241 may be formed on a side of the surface of the axis pin 240 facing the inner circumference of the housing 210.

A friction decrease groove 242 may be formed on the surface of the axis pin 240 facing the inner circumference of the housing 210 in a lengthwise direction to be connected to the resistance decrease groove 241. Thus, a contact area between the axis pin 240 and the inner circumference of the housing 210 may be minimized to reduce friction between the axis pin 240 and the housing 210.

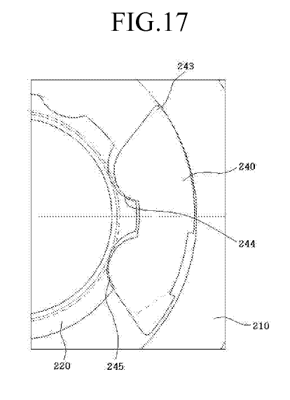

When the shaft 220 rotates in a counterclockwise direction as illustrated in FIGS. 14 to 16, contact portions 243, 244, and 245 of the axis pin 240 closely contact the inner circumference of the housing 210 and an outer circumference of the shaft 220, thereby preventing the working fluid from being moved due to the axis pin 240, as illustrated in FIG. 17.

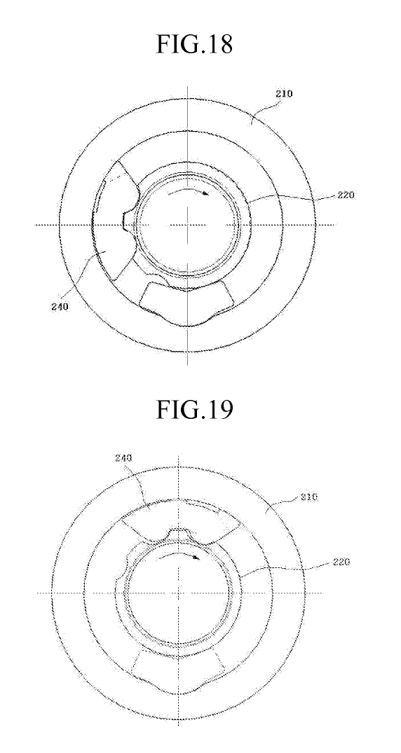

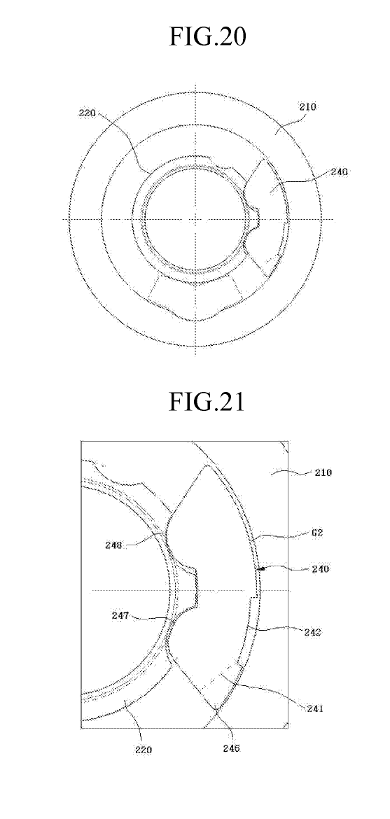

In contrast, when the shaft 220 rotates in a clockwise direction as illustrated in FIGS. 18 to 20, the other contact portions 246, 247, and 248 of the axis pin 240 closely contact the inner circumference of the housing 210 and the outer circumference of the shaft 220, akin to the rotary-type damper 100 according to the first embodiment, but the working fluid may pass through a gap G2 formed between the axis pin 240 and the inner circumference of the housing 210 via the resistance decrease groove 241, as in FIG. 21, since the resistance decrease groove 241 is formed near the contact portion 246 contacting the inner circumference of the housing 210, thereby reducing or suppressing the dampening action.

Although some embodiments of the present invention have been shown and described with reference to the accompanying drawings, it will be appreciated by those of ordinary skill in the art that changes can be made to these exemplary embodiments without departing from the principle and spirit of the invention along with the scope of which is defined in the appended claims and their equivalents.

According to one aspect of the present invention, there is provided a rotary type damper including a housing filled with a working fluid; a shaft installed to be rotatable while passing through the inside of the housing; a housing pin placed on an inner circumference of the housing to reach a side of the shaft, and configured to limit the movement of the working fluid; and an axis pin coupled to the shaft to rotate together with the shaft, and closely contacting the side of the shaft and the inner circumference of the housing as the position of the axis pin varies according to a rotation direction of the shaft.

The axis pin may be coupled to the side of the shaft such that the axis pin rotates in opposite directions according to the rotation direction of the shaft and a resistance between the axis pin and the working fluid.

Both sides of the axis pin may closely contact the side of the shaft and the inner circumference of the housing, respectively, according to the resistance of the working fluid, with respect to the center of the axis pin.

The axis pin may be meshed with the shaft in a circumferential direction of the shaft while having a clearance with the shaft.

A first insertion groove having a curvature may be formed in one of a side of the axis pin and a side of the shaft, and a first insertion projection having a curvature may be formed on the other to be inserted into the first insertion groove.

A pair of first insertion grooves and a pair of first insertion projections may be formed in parallel at a predetermined interval.

Linear contact portions may be formed at both sides of the axis pin to cause the axis pin to linearly contact the inner circumference of the housing when the axis pin closely contacts the inner circumference of the housing.

Both side surfaces of the axis pin may be formed to be inclined with respect to a radius of rotation of the shaft.

A resistance decrease groove may be formed in the axis pin to allow the working fluid therethrough when the shaft rotates only in one direction.

The resistance decrease groove may be formed in a side of a surface of the axis pin facing the inner circumference of the housing.

A friction decrease groove may be formed in the surface of the axis pin facing the inner circumference of the housing in a lengthwise direction to be connected to the resistance decrease groove.

The housing pin may be installed on the housing such that the position of the housing pin varies according to the rotation direction of the shaft and the resistance of the working fluid to cause the housing pin to closely contact the side of the shaft and the inner circumference of the housing.

The housing pin may be meshed with the inner circumference of the housing in a circumferential direction of the housing while having a clearance with the housing.

A second insertion groove having a curvature may be formed in one of the housing pin and the inner circumference of the housing, and a second insertion projection having a curvature may be formed on the other to be inserted into the second insertion groove.

The housing pin may be shaft-coupled to a bottom surface of the housing to be rotatable with respect to the bottom surface of the housing.

Linear contact portions may be formed at both sides of a portion of the housing pin facing the shaft to cause the housing pin to linearly contact the shaft when the housing pin closely contacts the shaft.

Both side surfaces of the housing pin may be formed to be inclined with respect to the radius of rotation of the shaft.

1. A rotary type damper comprising:
a housing filled with a working fluid;
a shaft installed to be rotatable while passing the inside of the housing;
a housing pin placed on an inner circumference of the housing to reach a side of the shaft, and configured to limit movement of the working fluid; and
an axis pin coupled to the shaft to rotate together with the shaft, and closely contacting the side of the shaft and the inner circumference of the housing as the position of the axis pin varies according to a rotation direction of the shaft.

2. The rotary type damper of claim 1, wherein the axis pin is coupled to the side of the shaft such that the axis pin rotates in opposite directions according to the rotation direction of the shaft and a resistance between the axis pin and the working fluid thereby.

3. The rotary type damper of claim 2, wherein both sides of the axis pin closely contact the side of the shaft and the inner circumference of the housing, respectively, according to the resistance of the working fluid with respect to the center of the axis pin.

4. The rotary type damper of claim 1, wherein the axis pin is meshed with the shaft in a circumferential direction of the shaft while having a clearance with the shaft.

5. The rotary type damper of claim 4, wherein a first insertion groove having a curvature is formed in one of a side of the axis pin and a side of the shaft, and
a first insertion projection having a curvature is formed on the other to be inserted into the first insertion groove.

6. The rotary type damper of claim 5, wherein a pair of first insertion grooves and a pair of first insertion projections are formed in parallel at a predetermined interval.

7. The rotary type damper of claim 1, wherein linear contact portions are formed at both sides of the axis pin to cause the axis pin to linearly contact the inner circumference of the housing when the axis pin closely contacts the inner circumference of the housing.

8. The rotary type damper of claim 1, wherein both side surfaces of the axis pin are formed to be inclined with respect to a radius of rotation of the shaft.

9. The rotary type damper of claim 1, wherein a resistance decrease groove is formed in the axis pin to allow the working fluid therethrough when the shaft rotates only in one direction.

10. The rotary type damper of claim 9, wherein the resistance decrease groove is formed in a side of a surface of the axis pin facing the inner circumference of the housing.

11. The rotary type damper of claim 10, wherein a friction decrease groove is formed in the surface of the axis pin facing the inner circumference of the housing in a lengthwise direction to be connected to the resistance decrease groove.

12. The rotary type damper of claim 1, wherein the housing pin is installed on the housing such that the position of the housing pin varies according the rotation direction of the shaft and a resistance of the working fluid thereby, and to cause the housing pin to closely contact the side of the shaft and the inner circumference of the housing.

13. The rotary type damper of claim 12, wherein the housing pin is meshed with the inner circumference of the housing in a circumferential direction of the housing while having a clearance with the housing.

14. The rotary type damper of claim 13, wherein a second insertion groove having a curvature is formed in one of the housing pin and the inner circumference of the housing, and
a second insertion projection having a curvature is formed on the other to be inserted into the second insertion groove.

15. The rotary type damper of claim 12, wherein the housing pin is shaft-coupled to a bottom surface of the housing to be rotatable with respect to the bottom surface of the housing.

16. The rotary type damper of claim 12, wherein linear contact portions are formed at both sides of a portion of the housing pin facing the shaft to cause the housing pin to linearly contact the shaft when the housing pin closely contacts the shaft.

17. The rotary type damper of claim 12, wherein both side surfaces of the housing pin are formed to be inclined with respect to the radius of rotation of the shaft.
